(19) United States
(12) Patent Application Publication
(10) Pub. No.: US 2026/0078269 A1
(43) Pub. Date: Mar. 19, 2026

(54) POLYMERIC COMPOSITIONS WITH STILBENE-BASED PROCESSING AIDS

(71) Applicant: CAMBIUM BIOMATERIALS, INC., El Segundo, CA (US)

(72) Inventors: Andrew John GUENTHNER, Alameda, CA (US); Egle MCCLAIN, Ridgecrest, CA (US); Edward Boynton TRIGG, Redondo Beach, CA (US); Christopher Michael SAHAGUN, Redondo Beach, CA (US); Andrea Effron MAEL, Lancaster, CA (US)

(73) Assignee: CAMBIUM BIOMATERIALS, INC., El Segundo, CA (US)

(21) Appl. No.: 19/402,104

(22) Filed: Nov. 26, 2025

Related U.S. Application Data
(63) Continuation of application No. PCT/US2024/030987, filed on May 24, 2024.
(60) Provisional application No. 63/504,635, filed on May 26, 2023.

(51) Int. Cl. C09D 5/29; C08K 5/13; C08K 5/1545; C09D 5/32; C09D 7/63; C09D 133/12; C09J 7/38; C09J 11/06; G02B 5/22

(52) U.S. Cl. CPC C09D 5/29; C09D 5/32; C09D 7/63; C09D 133/12; C09J 7/38; C09J 11/06; G02B 5/223; C08K 5/13; C08K 5/1545; C09J 2301/302; C09J 2301/408

(57) ABSTRACT

Disclosed are photosensitive elements, photosensitive solutions, and methods for forming same. The photosensitive element includes a layer disposed over a transparent substrate or an organic matrix having at least one of a polyfunctional hydroxy-stilbene-based additive and an alkoxy-stilbene-based additive and an organic electro-optical compound having a xanthene backbone.

### CROSS-REFERENCE TO RELATED APPLICATIONS

This application is a continuation of International Application No. PCT/US2024/030987, filed on May 24, 2024, which claims priority to and the benefit of U.S. Provisional Application No. 63/504,635, filed on May 26, 2023, the disclosures of which are incorporated herein by reference in their entirety.

### FIELD

The present disclosure relates to photosensitive elements and compositions for reducing transmittance of electromagnetic radiation at particular wavelengths.

### BACKGROUND

The statements in this section merely provide background information related to the present disclosure and may not constitute prior art.

Optical elements, such as a lens, prism, or other elements, may be tailored to absorb light at particular wavelengths, reduce light scattering, transmission, reduce laser light transmission, and the like. In many conventional approaches, dyes may be used to provide such desired optical profiles.

### SUMMARY

This section provides a general summary of the disclosure and is not a comprehensive disclosure of its full scope or all of its features.

According to one form of the present disclosure, a photosensitive element includes a transparent substrate and a layer disposed over at least a portion of a surface of the transparent substrate. The layer includes at least one of a polyfunctional hydroxy-stilbene-based additive and an alkoxy-stilbene-based additive and an organic electro-optical compound having a xanthene backbone.

In variations of this form, which may be implemented individually or in any combination: the organic electro-optical compound is xanthene; the organic electro-optical compound is rhodamine; the organic electro-optical compound is rhodamine 6G; the photosensitive element further includes at least one of a fluorescence quencher, an ultraviolet light stabilizer, a viscosity modifier, and a surfactant; the absorbance of the layer to light having a wavelength of 532 nm is greater than or equal to about 0.5 absorbance units; the transmittance of the layer to light having a wavelength of 532 nm is less than or equal to about 50 percent; the layer is disposed over the transparent substrate via a pressure sensitive adhesive; the layer includes a photostable polymer matrix; the photostable polymer matrix includes a plurality of polymer chains defining at least a molecularly ordered domain; the plurality of polymer chains are selected from the group consisting of cyclic olefin copolymers, atactic polypropylene, polystyrene, poly(methyl methacrylate), polycarbonate, copolymers thereof, amorphous copolyester, transparent acrylonitrile-butadiene-styrene, and mixtures thereof; the photostable polymer matrix is at less than or equal to about 1% of the at least a molecularly ordered domain; additive includes at least one of resveratrol, cis-resveratrol, alkylated cis/trans-resveratrol, piceatannol, pinosylvin, and polyfunctional hydroxy- or alkoxy-dihydrostilbene derivatives; the additive includes polyfunctional hydroxy- or alkoxy-dihydrostilbene derivatives of a dihydroresveratrol, dihydropiceatannol, or a dihydropinoxylvin; and/or the additive is cis-resveratrol; the additive is tripropylresveratrol.

According to a second form, a photosensitive composition includes an organic matrix of formed of at least one of a thermoplastic polymer and a thermosetting polymer, at least one of a polyfunctional hydroxy-stilbene-based additive and an alkoxy-stilbene-based additive, and an organic electro-optical compound having a xanthene backbone.

In variations of this form, which may be implemented individually or in any combination: the organic electro-optical compound is at greater than 0 wt. % to less than or equal to about 1 wt. % of the photosensitive composition; the organic electro-optical compound is xanthene; the organic electro-optical compound is rhodamine; the organic electro-optical compound is rhodamine 6G; the additive is at greater than 0 wt. % to less than or equal to about 5 wt. % of the photosensitive composition; the photosensitive composition further includes a secondary additive of at least one of a fluorescence quencher, an ultraviolet light stabilizer, a viscosity modifier, and a surfactant; the secondary additive is at greater than 0 wt. % to less than or equal to about 10 wt. % of the photosensitive composition; the absorbance of the photosensitive composition to light having a wavelength of 532 nm is greater than or equal to about 0.5 absorbance units; the transmittance of the photosensitive composition to light having a wavelength of 532 nm is less than or equal to about 50 percent; the photosensitive composition is formed into a photosensitive element and the photosensitive element is secured to a substrate via a pressure sensitive adhesive; the organic matrix material further includes a photostable polymer matrix; the photostable polymer matrix includes a plurality of polymer chains defining at least a molecularly ordered domain; the plurality of polymer chains are selected from the group consisting of cyclic olefin copolymers, atactic polypropylene, polystyrene, poly(methyl methacrylate), polycarbonate, copolymers thereof, amorphous copolyester, transparent acrylonitrile-butadiene-styrene, and mixtures thereof; the photostable polymer matrix is at less than or equal to about 1% of the at least a molecularly ordered domain; additive includes at least one of resveratrol, cis-resveratrol, alkylated cis/trans-resveratrol, piceatannol, pinosylvin, and polyfunctional hydroxy- or alkoxy-dihydrostilbene derivatives; the additive includes polyfunctional hydroxy- or alkoxy-dihydrostilbene derivatives of a dihydroresveratrol, dihydropiceatannol, or a dihydropinoxylvin; the additive is cis-resveratrol; and/or the additive is tripropylresveratrol.

According to a third form, a method of forming a photosensitive element includes mixing at least one of a polyfunctional hydroxy-stilbene-based additive and an alkoxy-stilbene-based additive and an organic electro-optical compound to form a photosensitive mixture; dispersing the photosensitive mixture throughout an organic material to form a dispersed photosensitive mixture, the organic material including at least one of a thermoplastic polymer and a thermosetting polymer; and forming a photosensitive element from the dispersed photosensitive mixture.

In variations of this form, which may be implemented individually or in any combination: the organic electro-optical compound is at greater than 0 wt. % to less than or equal to about 1 wt. % of the photosensitive composition; the organic electro-optical compound is xanthene; the organic electro-optical compound is rhodamine; the organic electro-optical compound is rhodamine 6G; the additive is at greater than 0 wt. % to less than or equal to about 5 wt. % of the photosensitive composition; the photosensitive composition further includes a secondary additive of at least one of a fluorescence quencher, an ultraviolet light stabilizer, a viscosity modifier, and a surfactant; the secondary additive is at greater than 0 wt. % to less than or equal to about 10 wt. % of the photosensitive composition; the absorbance of the photosensitive composition to light having a wavelength of 532 nm is greater than or equal to about 0.5 absorbance units; the transmittance of the photosensitive composition to light having a wavelength of 532 nm is less than or equal to about 50 percent; the photosensitive element is secured to a substrate via a pressure sensitive adhesive; the organic matrix material further includes a photostable polymer matrix; the photostable polymer matrix includes a plurality of polymer chains defining at least a molecularly ordered domain; the plurality of polymer chains are selected from the group consisting of cyclic olefin copolymers, atactic polypropylene, polystyrene, poly(methyl methacrylate), polycarbonate, copolymers thereof, amorphous copolyester, transparent acrylonitrile-butadiene-styrene, and mixtures thereof; the photostable polymer matrix is at less than or equal to about 1% of the at least a molecularly ordered domain; additive includes at least one of resveratrol, cis-resveratrol, alkylated cis/trans-resveratrol, piceatannol, pinosylvin, and polyfunctional hydroxy- or alkoxy-dihydrostilbene derivatives; the additive includes polyfunctional hydroxy- or alkoxy-dihydrostilbene derivatives of a dihydroresveratrol, dihydropiceatannol, or a dihydropinoxylvin; the additive is cis-resveratrol; and/or the additive is tripropylresveratrol.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic drawing of a photosensitive element according to the present disclosure;

FIG. 2 is a graph depicting red-green color balance of photosensitive elements according to the present disclosure compared with conventional photosensitive elements; and

FIG. 3 is a graph depicting haze of photosensitive elements according to the present disclosure compared with conventional photosensitive elements.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

According to the teachings of the present disclosure, a photosensitive element includes an additive having at least one of a polyfunctional hydroxy-stilbene-based additive and an alkoxy-stilbene-based additive and an organic electro-optical compound.

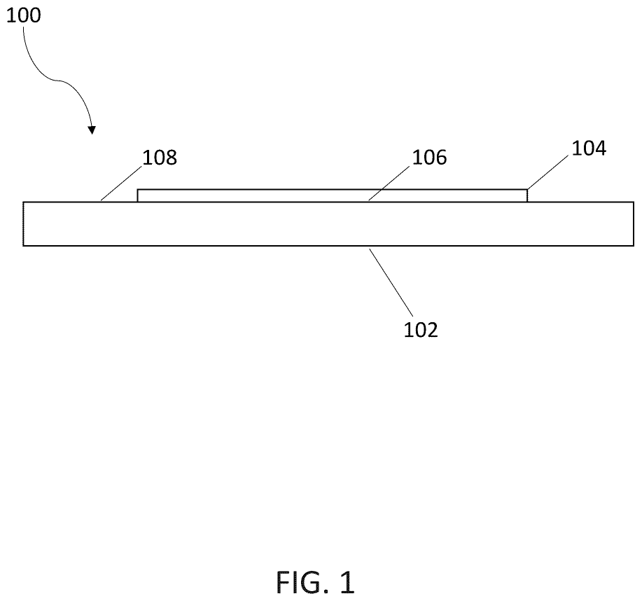

Referring to FIG. 1, in one form, a photosensitive element 100 (also referred to herein as an optical element) includes a substrate 102 (e.g., a transparent substrate) and a layer 104 disposed over at least a portion 106 of a surface 108 of the substrate 102. In one form, the substrate 102 is transparent, but it should be understood that the substrate may have a variety of opacities while remaining within the scope of the present disclosure. The layer 104 includes at least an additive comprising at least one of a polyfunctional hydroxy-stilbene-based additive and an alkoxy-stilbene-based additive and an organic electro-optical compound. In variations, the layer 104 is in the form of a coating, film, layer, a thermoplastic polyurethane (referred to herein also as a TPU) or polymethyl methacrylate (referred to herein also as PMMA) applique, infused TRIVEX® optical lenses, commercially available from PPG Industries, or the like, applied according to known processes, included but not limited to solvent-based casting of films, solvent-free casting, additive manufacturing, photo-polymerization (also referred to herein as stereolithography or SLA) of films, thermal-polymerization of films, melt mixing processes, sol gel processes, thermal spraying, physical vapor deposition, among others. In some such processes, before forming the layer 104, the photosensitive element 100 optionally has pre-applied coatings removed therefrom. Further, the surface of the photosensitive element 100 may be polished, ground, or the like, to remove imperfections and the like. And in some such processes, after forming the layer 104, the photosensitive element 100 may thereafter be rinsed, dried, further machined and/or cut, and cleaned, or rinsed, re-grinded, and re-polished, among other surface treatments.

In some variations, the layer 104 may further include a pressure sensitive adhesive configured to secure the layer 104 over the at least a portion 106 of the surface 108 of the substrate 102. The pressure sensitive adhesive may be reusable. In variations, the substrate may be in the form of optical lenses (e.g., sunglasses), a cover for a rifle scope, or other optical elements having the optical parameters described herein. In variations where the layer 104 is formed over at least a surface 108 of the photosensitive element 100, it is contemplated the layer 104 is greater than or equal to about 0.01 mm thick to less than or equal to about 1 cm thick. In one form, the layer 104 is greater than or equal to about 1 mm to less than or equal to about 10 mm. In yet another form, the layer 104 is greater than or equal to about 3 mm to less than or equal to about 8 mm. Lateral dimensions of the layer 104 are not similarly constrained.

In another variation, a photosensitive element (such as the photosensitive element 100) includes an organic matrix material. In one form, the organic matrix material is formed of at least one of a thermoplastic polymer and a thermosetting polymer, though it is contemplated other organic matrix materials may remain within the scope of the present disclosure. The organic matrix material further includes at least one of a polyfunctional hydroxy-stilbene-based additive and an alkoxy-stilbene-based additive and an organic electro-optical compound (the additive, organic electro-optical compound, and organic matrix material collectively defining a photosensitive composition).

As used herein, polyfunctional hydroxy-stilbene-based additives include stilbene-based structures having a hydroxy function at two or more of the carbon loci of the phenyl rings.

As used herein, alkoxy-stilbene-based additives include stilbene-based structures having an alkoxy group at one of the carbon loci of the phenyl rings.

Accordingly, applicable stilbene-based additives include stilbenes and stilbenoids, such as 3,5,4′-trihydroxystilbene, commonly known as Resveratrol, or trans-Resveratrol; cis-Resveratrol; alkylated cis- or trans-Resveratrol; hydroxylated or alkoxylated piceatannol; hydroxylated or alkoxylated pinosylvin; polyfunctional hydroxy- or alkoxy-dihydrostilbene derivatives, including, but not limited to dihydroresveratrol, dihydropiceatannol, and dihydropinoxylvin; as well as other alkoxylated or hydroxylated stilbenes or stilbenoids. Additional exemplary additives include tripropylresveratrol. Examples of tripropylresveratrol are shown below, including the tris(n-propyl ether) derived from alkylation of trans-resveratrol (General Formula (1)), the tris(isopropyl ether) derived from trans-resveratrol (General Formula (2)), the tris(n-propyl ether) derived from cis-resveratrol (General Formula (3)), and the tris(n-propyl ether) derived from dihydroresveratrol (General Formula (4)), among others:

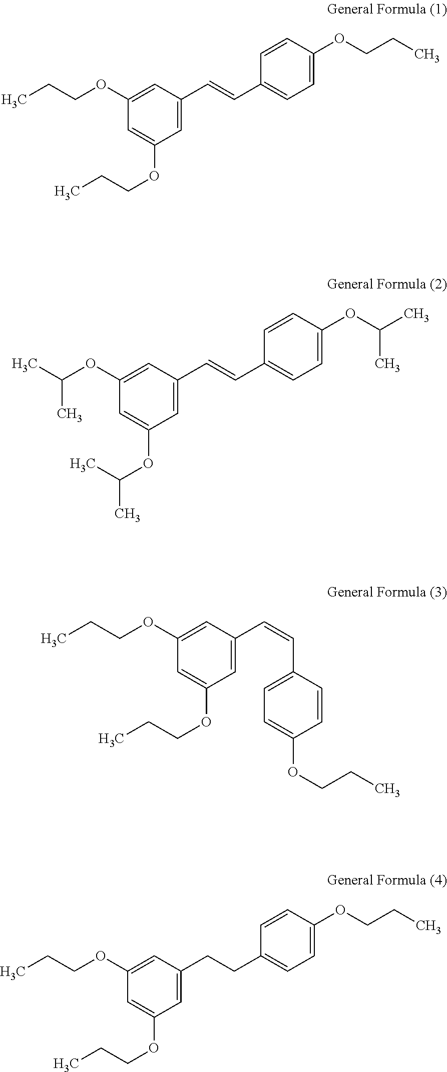

Such polyfunctional hydroxy-stilbene-based additives and an alkoxy-stilbene-based additives act as processing aids with the organic electro-optical compound. More specifically, the additives disclosed herein reduce aggregation of the organic electro-optical compound, inhibit degradation of the organic electro-optical compound that may occur from ultraviolet light radiation, and/or quench fluorescence of the organic electro-optical compound. Without wishing to be bound by theory, it is believed the additives and organic electro-optical compounds disclosed herein have complementary structures that facilitate such reductions in aggregation and quenches in fluorescence.

As used herein, an organic matrix material includes thermoplastics, thermosets, and blends thereof. Non-limiting examples include polyurethane, polycarbonate, poly(acrylate), adducts of epoxy monomers and oligomers, polysiloxane, and blends thereof, among others. In some aspects, the organic matrix material includes at least one of a polymerizable monomer, a polymerizable oligomer, a cross-linkable oligomer, and a thermoplastic polymer. The organic matrix material may be formed of a photostable polymer matrix. In some variations, the photostable polymer matrix includes a plurality of polymer chains that define a molecularly ordered domain (e.g., crystalline or semicrystalline). In variations, at most about 1% by volume of the photostable polymer matrix is in a molecularly ordered domain. The plurality of polymer chains may be one or more of TPU, cyclic olefin copolymers, atactic polypropylene, polystyrene, PMMA, polycarbonate, copolymers thereof, amorphous copolyester, transparent acrylonitrile-butadiene-styrene, and mixtures thereof.

As used herein, an organic electro-optical compound includes those that have one or more donor and/or acceptor moieties bonded to a pi-electron framework having a xanthene backbone. According to a variation, the organic electro-optical compound is xanthene. In other variations, the organic electro-optical compound is at least a rhodamine, such as rhodamine B, rhodamine 123, and rhodamine 6G. In yet other variations, the organic electro-optical compound is rhodamine 6G. Other xanthene dyes, such as fluorescein and eosins are also contemplated to be within the scope of the present disclosure. Other organic compounds having complementary structures with the additives disclosed herein are also considered to be within the scope of the present disclosure.

It is further contemplated that there may be additional additives (also referred to as secondary additives). Non-limiting examples of such additional additives include at least one or more of a fluorescence quencher, an ultraviolet light stabilizer, a viscosity modifier, and a surfactant, among others.

In variations of photosensitive elements including an organic matrix material, at least one of a polyfunctional hydroxy-stilbene-based additive and an alkoxy-stilbene-based additive, and an organic electro-optical compound, the organic matrix material may be at greater than or equal to about 0.1 wt. % to less than or equal to about 99.99 wt. % of the photosensitive element, the additive having at least one of a polyfunctional hydroxy-stilbene-based additive and an alkoxy-stilbene-based additive at greater than or equal to about 0.0001 wt. % to less than or equal to about 5 wt. %, and the organic electro-optical additive at greater than or equal to about 0.0001 wt. % to less than or equal to about 1 wt. %, including all sub-ranges. In other variations, the organic matrix material is at greater than or equal to about 10 wt. % to less than or equal to about 99.9 wt. %. In yet other variations, the organic matrix material is at greater than or equal to about 50 wt. % to less than or equal to about 99.9 wt. %. In further variations, the electro-optical organic additive is at greater than or equal to about 0.01 wt. % to less than or equal to about 0.1 wt. %. In yet further variations, the electro-optical organic additive is at greater than or equal to about 0.001 wt. % to less than or equal to about 1 wt. %. And in other variations, the additive is at greater than or equal to about 0.01 wt. % to less than or equal to about 1 wt. %. And in yet other variations, the additive is at greater than or equal to about 0.01 wt. % to less than or equal to about 0.2 wt. %. Where the photosensitive element includes additional additives, such additional additives may be at greater than or equal to about 0.0001 wt. % to less than or equal to about 10 wt. %, including all sub-ranges.

The photosensitive elements according to the present disclosure transmit less than or equal to about 50% of light having a wavelength of 532 nm (e.g., about 0.3 absorbance units). In yet other variations, the photosensitive elements according to the present disclosure transmit less than 50% of light having a wavelength of greater than or equal to about 520 nm to less than or equal to about 550 nm. In other variations, the photosensitive elements according to the present disclosure transmit less than 90% of light having a wavelength of greater than or equal to about 520 nm to less than or equal to about 550 nm. In other variations, the photosensitive elements according to the present disclosure transmit greater than or equal to about 0.00001% of light having a wavelength of 532 nm (e.g., about 10 absorbance units) to less than or equal to about 50% of light having a wavelength of 532 nm. In further variations, the photosensitive elements according to the present disclosure transmit less than or equal to about 0.1% of light having a wavelength of 532 nm (e.g., about 3 absorbance units). In further variations, the photosensitive elements according to the present disclosure exhibit absorbance of about 2.5 absorbance units having a wavelength of 532 nm. In yet other variations, the photosensitive elements according to the present disclosure may exhibit virtually 100% absorption of light at a wavelength of 532 nm.

The quality of the light absorbing properties of the photosensitive elements may be dictated at least in part by the methods in which the photosensitive element is prepared (e.g., whether the photosensitive element was a deposited layer, a cast layer, an infusion into an optical element, such as an optical lens, among others).

A method of making an optical element (such as optical element 100) mixing an additive with an organic electro-optical compound to form a photosensitive mixture. The additive includes at least one of a polyfunctional hydroxy-stilbene-based additive and an alkoxy-stilbene-based additive. The photosensitive mixture is dispersed throughout an organic material to form a dispersed photosensitive mixture. The organic material includes at least one of a thermoplastic polymer and a thermosetting polymer. A photosensitive element is then formed from the dispersed photosensitive mixture.

Examples of optical elements, in the forms of optical films, according to the present disclosure and comparative examples, prepared by conventional means, were prepared and are now discussed.

### Comparative Example 1

2.000 parts-by-weight (in grams) of poly(methyl methacrylate), 0.001 parts-by-weight (in grams) of rhodamine 6G, and 10.000 parts-by-weight (in grams) of acetone were combined in a 20 mL glass vial equipped with a magnetic stir bar and the resulting mixture was held at 45° C. with stirring for 4 h or until fully dissolved. A portion of the resulting solution was drop-cast on a glass slide and subjected to slow evaporation under an inverted beaker. An optical film formed over the glass slide (referred to herein as a comparative film A or a film A) and was tested to reveal optical characteristics of λ max=532 nm, abs=1 a.u. (normalized); 506 nm, abs=0.42 a.u.

### Example 1

2.000 parts-by-weight (in grams) of poly(methyl methacrylate), 0.001 parts-by-weight (in grams) of rhodamine 6G, and 10.000 parts-by-weight (in grams) of acetone, and 0.002 parts-by-weight (in grams) of Isomer 1 were combined in a 20 mL glass vial equipped with a magnetic stir bar and the resulting mixture was held at 45° C. with stirring for 4 h or until fully dissolved. A portion of the resulting solution was drop-cast on a glass slide and subjected to slow evaporation under an inverted beaker. An optical film formed over the glass slide (referred to herein as film B) and was tested to reveal optical characteristics of λ max=532 nm, abs=1 a.u. (normalized); 500 nm, abs=0.37 a.u. The film B exhibited a lower absorption peak at ca. 500 nm than that of comparative film A. Without wishing to be bound by theory, it is believed that the additive (cis-Resveratrol) synergistically reduces aggregation of the organic electro-optical compound (e.g., rhodamine 6G). Additionally, visible film fluorescence was significantly quenched.

### Comparative Example 2

180.000 parts-by-weight (in grams) of propylene glycol monomethyl ether, 20 parts-by-weight (in grams) of dipropylene glycol monomethyl ether, and 1.000 parts-by-weight (in grams) of rhodamine 6G were combined in a narrow glass container and heated to 55° C. with stirring until fully dissolved. A thermoplastic polyurethane (TPU) film (Armorsuit Dry MilitaryShield) was then immersed in the resulting solution and held for 20 min at 50-55° C. The film was then rinsed with deionized water and allowed to dry or applied to an optically transparent substrate resulting in a comparative photosensitive element C (referred to herein as a comparative film C or a film C) and was tested to reveal optical characteristics of λ max=532 nm, abs=2.5-3+ a.u.

### Example 2

180.000 parts-by-weight (in grams) of propylene glycol monomethyl ether, 20 parts-by-weight (in grams) of dipropylene glycol monomethyl ether, 1.000 parts-by-weight (in grams) of rhodamine 6G, and 1.000 parts-by-weight (in grams) of tri-n-propyl trans-resveratrol were combined in a narrow glass container and heated to 55° C. with stirring until fully dissolved. A thermoplastic polyurethane (TPU) film (Armorsuit Dry MilitaryShield) was then immersed in the resulting solution and held for 20 min at 50-55° C. The film was then rinsed with deionized water and allowed to dry or applied to an optically transparent substrate resulting in a photosensitive element (referred to herein as photosensitive element D) and was tested to reveal optical characteristics of λ max=532 nm, abs=2.5-3+ a.u.

### Example 3

180.000 parts-by-weight (in grams) of propylene glycol monomethyl ether, 20 parts-by-weight (in grams) of dipropylene glycol monomethyl ether, 1.000 parts-by-weight (in grams) of rhodamine 6G, and 5.000 parts-by-weight (in grams) of tri-n-propyl trans-resveratrol were combined in a narrow glass container and heated to 55° C. with stirring until fully dissolved. A thermoplastic polyurethane (TPU) film (Armorsuit Dry MilitaryShield) was then immersed in the resulting solution and held for 20 min at 50-55° C. The film was then rinsed with deionized water and allowed to dry or applied to an optically transparent substrate resulting in a photosensitive element (referred to herein as photosensitive element E) and was tested to reveal optical characteristics of λ max=532 nm, abs=2.6-3+ a.u.

### Example 4

180.000 parts-by-weight (in grams) of propylene glycol monomethyl ether, 20 parts-by-weight (in grams) of dipropylene glycol monomethyl ether, 1.000 parts-by-weight (in grams) of rhodamine 6G, and 1.000 parts-by-weight (in grams) of tri-n-propyl trans-resveratrol were combined in a glass container and heated to 79° C. with stirring until fully dissolved. An uncoated Trivex lens blank (Essilor) was then immersed in the resulting solution and held at 79° C. for 20 min. The lens was then rinsed with deionized water and cleaned with acetone, resulting in a photosensitive element (referred to herein as photosensitive element F) and was tested to reveal optical characteristics of λ max=532 nm, abs≥3 a.u.

### Example 5

1000 parts-by-weight (in grams) of Clear Resin (FormLabs RS-F2-GPCL-04), 0.2 parts-by-weight (in grams) of rhodamine 6G, and 1 parts-by-weight (in grams) of tri-n-propyl trans-resveratrol were combined in a container to yield a homogeneous mixture. Part of the mixture was loaded into a FormLabs Form 3+ 3D printer, a geometric code of machine-readable instructions for defining the path of a 3D printer during 3D printing was generated describing an appropriate lens shape, and the lens was printed using standard Form 3+ printing parameters (the lens should be oriented diagonally so that the lens face is neither lying flat on the build plate nor orthogonal to the build plate). Residual monomeric resin was removed from the lens using an alcohol wash station, and the lens was polished/buffed, resulting in a photosensitive element (referred to herein as photosensitive element G) and was tested to reveal optical characteristics of λ max=532 nm, abs≥3 a.u.

### Example 6

100 parts-by-weight (in grams) of castable polyester resin (with catalyst), 0.02 parts-by-weight (in grams) of rhodamine 6G, and 0.1 parts-by-weight (in grams) of tri-n-propyl trans-resveratrol were combined in a container to yield a homogeneous mixture. Part of the mixture was cast into silicone molds (50 mm×3 mm discs), locally heated to remove bubbles and allowed to cure for 24-48 hours. The resulting resin disc was then polished/buffed, resulting in a photosensitive element (referred to herein as photosensitive element H) and was tested to reveal optical characteristics of λ max=532 nm, abs≥3 a.u.

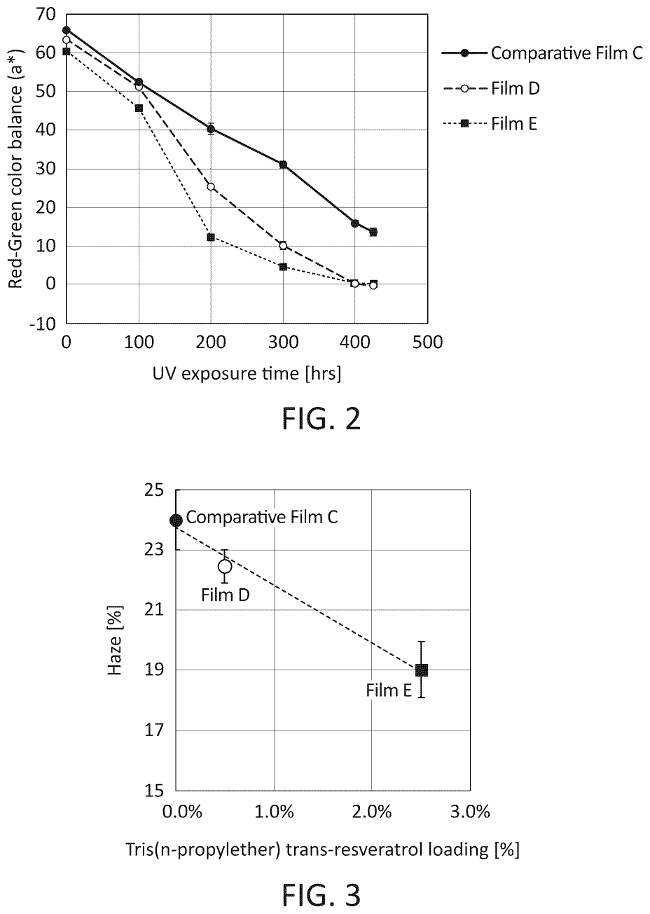

Referring to FIG. 2, photosensitive elements D and E exhibited better red-green color retention as a function of exposure to ultraviolet light in comparison with comparative film C. More specifically, red-green color retention was tested with an accelerated weathering tester adapted to run UVA 340 bulbs at 45° C. for 8 hours, followed by a second accelerated weathering tester without light and no condensation at 45° C. for 4 hours. This suggests the addition of additives according to the present disclosure inhibit degradation of the organic electro-optical compound in response to ultraviolet exposure.

Referring to FIG. 3, photosensitive elements D and E exhibited substantially less haze (shown as in comparison with comparative film C. Further, the effect appears to be more pronounced with higher concentrations of the additive, suggesting the presence and concentration of additives positively correlates with controlling haze.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A photosensitive element comprising:
a transparent substrate; and
a layer disposed over at least a portion of a surface of the transparent substrate, wherein the layer comprises:
at least one of a polyfunctional hydroxy-stilbene-based additive and an alkoxy-stilbene-based additive; and
an organic electro-optical compound comprising a xanthene backbone.

2. The photosensitive element according to claim 1, wherein the organic electro-optical compound comprises a rhodamine dye.

3. The photosensitive element according to claim 1, further comprising at least one of a fluorescence quencher, an ultraviolet light stabilizer, a viscosity modifier, and a surfactant.

4. The photosensitive element according to claim 1, wherein the absorbance of the layer to light having a wavelength of 532 nm is greater than or equal to about 0.5 absorbance units, and the transmittance of the layer to light having a wavelength of 532 nm is less than or equal to about 50 percent.

5. The photosensitive element according to claim 1, wherein the layer is disposed over the transparent substrate via a pressure sensitive adhesive.

6. The photosensitive element according to claim 1, wherein the layer further comprises a photostable polymer matrix comprising a plurality of polymer chains defining at least a molecularly ordered domain, and the plurality of polymer chains are selected from the group consisting of cyclic olefin copolymers, atactic polypropylene, polystyrene, poly(methyl methacrylate), polycarbonate, copolymers thereof, amorphous copolyester, transparent acrylonitrile-butadiene-styrene, and combinations thereof.

7. The photosensitive element according to claim 1, wherein the additive comprises a member of the group consisting of resveratrol, cis-resveratrol, tripropylresveratrol, alkylated cis/trans-resveratrol, piceatannol, pinosylvin, polyfunctional hydroxy- or alkoxy-dihydrostilbene derivatives, polyfunctional hydroxy- or alkoxy-dihydrostilbene derivatives of a dihydroresveratrol, polyfunctional hydroxy- or alkoxy-dihydrostilbene derivatives of a dihydropiceatannol, polyfunctional hydroxy- or alkoxy-dihydrostilbene derivatives of a dihydropinoxylvin, and combinations thereof.

8. A photosensitive composition comprising:
an organic matrix material comprised of at least one of a thermoplastic polymer and a thermosetting polymer;
at least one of a polyfunctional hydroxy-stilbene-based additive and an alkoxy-stilbene-based additive; and
an organic electro-optical compound comprising a xanthene backbone.

9. The photosensitive composition according to claim 8, wherein the organic electro-optical compound is at greater than 0 wt. % to less than or equal to about 1 wt. % of the photosensitive composition, and the organic electro-optical compound comprises a rhodamine dye, and wherein the additive is at greater than 0 wt. % to less than or equal to about 5 wt. % of the photosensitive composition.

10. The photosensitive composition according to claim 8, further comprising a secondary additive selected from the group consisting of a fluorescence quencher, an ultraviolet light stabilizer, a viscosity modifier, and a surfactant, wherein the secondary additive is at greater than 0 wt. % to less than or equal to about 10 wt. % of the photosensitive composition.

11. The photosensitive composition according to claim 8, wherein the absorbance of the photosensitive composition to light having a wavelength of 532 nm is greater than or equal to about 0.5 absorbance units, and the transmittance of the photosensitive composition to light having a wavelength of 532 nm is less than or equal to about 50 percent.

12. The photosensitive composition according to claim 8, wherein the photosensitive composition is formed into a photosensitive element and the photosensitive element is secured to a substrate via a pressure sensitive adhesive.

13. The photosensitive composition according to claim 8, wherein the organic matrix material further comprises a photostable polymer matrix comprising a plurality of polymer chains defining at least a molecularly ordered domain, and the plurality of polymer chains are selected from the group consisting of cyclic olefin copolymers, atactic polypropylene, polystyrene, poly(methyl methacrylate), polyurethane, polycarbonate, copolymers thereof, amorphous copolyester, transparent acrylonitrile-butadiene-styrene, and combinations thereof, and wherein the photostable polymer matrix is at less than or equal to about 1% of the at least a molecularly ordered domain.

14. The photosensitive composition according to claim 8, wherein the additive comprises a member of the group consisting of resveratrol, cis-resveratrol, alkylated cis/trans-resveratrol, tripropylresveratrol, piceatannol, pinosylvin, polyfunctional hydroxy- or alkoxy-dihydrostilbene derivatives, polyfunctional hydroxy- or alkoxy-dihydrostilbene derivatives of a dihydroresveratrol, polyfunctional hydroxy- or alkoxy-dihydrostilbene derivatives of a dihydropiceatannol, polyfunctional hydroxy- or alkoxy-dihydrostilbene derivatives of a dihydropinoxylvin, and combinations thereof.

15. A method of forming a photosensitive element, the method comprising:
mixing at least one of a polyfunctional hydroxy-stilbene-based additive and an alkoxy-stilbene-based additive and an organic electro-optical compound to form a photosensitive mixture;
dispersing the photosensitive mixture throughout an organic material, wherein the organic material is comprised of at least one of a thermoplastic polymer and a thermosetting polymer to form a dispersed photosensitive mixture; and
forming a photosensitive element from the dispersed photosensitive mixture.

16. The method according to claim 15, wherein the organic electro-optical compound is at greater than 0 wt. % to less than or equal to about 1 wt. % of the photosensitive element, and the organic electro-optical compound comprises a xanthene dye, and wherein the additive is at greater than 0 wt. % to less than or equal to about 5 wt. %.

17. The method according to claim 15, further comprising mixing with the additive and the organic electro-optical compound a secondary additive selected from the group consisting of a fluorescence quencher, an ultraviolet light stabilizer, a viscosity modifier, and a surfactant, wherein the secondary additive is at greater than 0 wt. % to less than or equal to about 10 wt. % of the photosensitive element.

18. The method according to claim 15, wherein the absorbance of the photosensitive element to light having a wavelength of 532 nm is greater than or equal to about 0.5 absorbance units, and the transmittance of the photosensitive element to light having a wavelength of 532 nm is less than or equal to about 50 percent.

19. The method according to claim 15, wherein the organic material further comprises a photostable polymer matrix comprising a plurality of polymer chains defining at least a molecularly ordered domain, and the plurality of polymer chains are selected from the group consisting of cyclic olefin copolymers, atactic polypropylene, polystyrene, poly(methyl methacrylate), polyurethane, polycarbonate, copolymers thereof, amorphous copolyester, transparent acrylonitrile-butadiene-styrene, and combinations thereof, and wherein the photostable polymer matrix is at less than or equal to about 1% of the at least a molecularly ordered domain.

20. The method according to claim 15, wherein the additive comprises a member of the group consisting of resveratrol, cis-resveratrol, tripropylresveratrol, alkylated cis/trans-resveratrol, piceatannol, pinosylvin, and polyfunctional hydroxy- or alkoxy-dihydrostilbene derivatives, polyfunctional hydroxy- or alkoxy-dihydrostilbene derivatives of a dihydroresveratrol, polyfunctional hydroxy- or alkoxy-dihydrostilbene derivatives of a dihydropiceatannol, polyfunctional hydroxy- or alkoxy-dihydrostilbene derivatives of a dihydropinoxylvin, and combinations thereof.
